(19) United States
(12) Patent Application Publication
(10) Pub. No.: US 2008/0028795 A1
(43) Pub. Date: Feb. 7, 2008

(54) FLOAT BATH AND FLOAT FORMING METHOD

(75) Inventors: Toru KAMIHORI, Tokyo (JP); Nobuyuki Ban, Tokyo (JP); Tetsushi Takiguchi, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: ASAHI GLASS CO., LTD., Tokyo (JP)

(21) Appl. No.: 11/836,388

(22) Filed: Aug. 9, 2007

Related U.S. Application Data
(63) Continuation of application No. PCT/JP2006/302166, filed on Feb. 8, 2006.

(30) Foreign Application Priority Data
Feb. 10, 2005 (JP) 2005-034669

(51) Int. Cl. C03B 18/00

(52) U.S. Cl. 65/136.2; 65/182.1

(57) ABSTRACT

An object of the invention is to provide a float bath and a float forming method which are capable of forming a glass having a high forming temperature without shortening the life of a strap for power feeding to a heater. The invention relates to a float bath which comprises a bottom filled with molten tin and a roof covering the bottom and in which the space in the roof is divided into an upper space and a lower space by a roof brick layer and a heater is disposed so as to penetrate a hole formed in the roof brick layer, wherein a heater end part located in the upper space has a feeding part having a strap attached thereto for feeding power to the heater, and wherein the heater end part is constituted so as to satisfy the following relationship: S′ₖ·εₖ+S′ₙ·εₙ≧3,630 mm², when the surface area and emissivity of the feeding part are expressed by S′ₖ and εₖ, respectively, and the surface area and emissivity of the heater end part excluding the feeding part are expressed by S′ₙ and εₙ, respectively.

### CROSS-REFERENCE TO RELATED APPLICATIONS

This application is a continuation of PCT/JP2006/302166, filed Feb. 8, 2006, which is based upon and claims the benefit of priority from Japanese Patent Application No. 2005-034669, filed on Feb. 10, 2005, the entire contents of each of which are incorporated herein by reference.

### TECHNICAL FIELD

The present invention relates to a float bath for glass plate production suitable for the float forming of a glass higher in the temperature at which the viscosity reaches 10⁴ poises (hereinafter this temperature is referred to as forming temperature) than soda-lime silica glass, and to a method for such float forming.

### BACKGROUND ART

Glass plates produced by the float forming of soda-lime silica glass in a molten state have hitherto been used extensively in applications such as window glasses for buildings, motor vehicles, and the like and glass substrates for STN liquid-crystal displays. At present, float forming has become a main method for producing soda-lime silica glass plates (see non-patent document 1).

A float bath is a huge molten-tin bath, and the space overlying the molten tin (the space covered with a roof) is divided into an upper space and a lower space by a roof brick layer. The roof brick layer has many holes formed therein, and many heaters (usually, heaters made of SiC) are disposed so as to penetrate these holes. These heaters are connected by electric wires through straps made of aluminum to, e.g., bus bars disposed in the upper space over the roof brick layer, and the atmosphere overlying the molten tin is heated by the heat generated by that heating part of each heater which projects into the lower space under the roof brick layer.

Incidentally, an alkali-free glass having a forming temperature higher by 100° C. or more than that of soda-lime silica glass is recently used as glass substrates for TFT liquid-crystal displays (TFT-LCDs). When these glass substrates are to be produced by a float process, the temperature of the molten-tin bath should be further elevated and, hence, the temperature of the space over the bath should also be kept higher.

Non-Patent Document 1: Masayuki Yamane et al., ed., Glass Engineering Hangbook, 1st edition, Asakura Publishing Co., Ltd., Jul. 5, 1999, pp. 358-362.

### DISCLOSURE OF THE INVENTION

### Problems that the Invention is to Solve

However, various problems arise when a float bath or float process established for soda-lime silica glass is to be used for forming the alkali-free glass, which has a forming temperature higher than that of soda-lime silica glass by 100° C. or more, into a glass plate. One of such problems concerns an increase in the temperature of the atmosphere in the upper space described above (hereinafter sometimes referred to simply as upper space) as will be described below.

As stated above, electric wiring parts such as bus bars and electric wires, heater end parts (including a heater feeding part having attached thereto a strap for power feeding to the heater and the part other than the heater feeding part), etc. are present in the upper space. The member which comes to have a highest temperature among those is the aluminum strap in a flat net string form directly attached to each heater feeding part which has an elevated temperature due to, e.g., thermal conduction from the heater heating part located in the lower space.

In case where this strap is damaged because of its high temperature and thus becomes unable to feed power to the heater to which the strap has been attached, it becomes impossible to conduct sufficient heating itself. The occurrence of such damage impairs the set-temperature control of the upper space of the float bath to arouse troubles concerning the production of glass plates of satisfactory quality. In case where this strap damage occurs in a large number, there is a possibility that a serious trouble concerning production might arise.

In order to prevent the trouble occurrence attributable to such strap damages, the upper-space atmosphere temperature Tᵣ is usually regulated so as not to exceed 300° C. The temperature of 300° C. which is the upper-limit temperature in regulating the upper-space atmosphere Tᵣ was established as a temperature which guarantees the nonoccurrence of a strap damage over a prolonged time period, e.g., 10 years, based on results/experiences obtained in the longtime application of the float process to soda-lime silica glass.

Incidentally, when a glass having a higher forming temperature than soda-lime silica glass (hereinafter the former glass is sometimes referred to as “high-viscosity glass”) is to be formed by the float process, the temperature of the molten tin in the float bath should be kept higher than in the case of the forming of soda-lime silica glass by the float process, resulting in an increased upper-space atmosphere temperature Tᵣ. When the upper-space atmosphere temperature Tᵣ might exceed 300° C., the flow rate by volume V_{g} of the atmosphere gas (typically, a nitrogen/hydrogen mixture gas) is usually increased. Namely, the atmosphere gas is forcedly circulated to remove heat from the surfaces of the heater end parts with the atmosphere gas flowing around the straps and thereby lower the temperature of the straps. Incidentally, the atmosphere gas is introduced into the upper space through a hole formed in, e.g., the top of the roof casing, cools the electrical wiring members, etc., and then flows into the lower space through holes of the roof brick layer to prevent the molten tin from oxidizing.

However, such an increase in the volume flow rate V_{g} not only brings about a vicious cycle of diminution of heater heating→heater output increase for compensating for the diminution→another increase in upper-space atmosphere temperature Tᵣ→increase in volume flow rate V_{g}, but also increases the possibility that tin defects (top specks) on the glass ribbon might generate or increase in number. Although glass substrates for TFT-LCDs are becoming larger in recent years and are increasingly required to have higher quality, the increase in top specks described above reduces production efficiency, in particular, the efficiency of production of the glass substrates of large sizes.

Furthermore, the properties required of glasses for use as those substrates have become high and glasses capable of satisfying the requirements have been developed. However, such glasses generally have an even higher forming temperature. Namely, the upper-space atmosphere temperature Tᵣ becomes even higher. Consequently, for forming a glass for TFT-LCD substrates by float forming, there comes to be a desire for a technique for inhibiting the strap temperature from increasing with the increasing upper-space atmosphere temperature Tᵣ without increasing the volume flow rate V_{g} (i.e., without causing the generation or increase of top specks).

An object of the invention is to provide a float bath and a float forming method which are capable of overcoming such problems.

### Means for Solving the Problems

The invention provides a float bath which comprises a bottom filled with molten tin and a roof covering the bottom and in which the space in the roof is divided into an upper space and a lower space by a roof brick layer and a heater is disposed so as to penetrate a hole formed in the roof brick layer, wherein a heater end part located in the upper space has a feeding part having a strap attached thereto for feeding power to the heater, and wherein the heater end part is constituted so as to satisfy the following relationship: S′ₖ·εₖ+S′ₙ·εₙ≧3,630 mm² when the surface area and emissivity of the feeding part are expressed by S′ₖ and εₖ, respectively, and the surface area and emissivity of the heater end part excluding the feeding part are expressed by S′ₙ and εₙ, respectively.

The invention further provides the float bath wherein the emissivity of the feeding part, εₖ, is 0.7 or higher and the emissivity of the heater end part excluding the feeding part, εₙ, is 1.0.

The invention furthermore provides the float bath wherein the heater is made of silicon carbide (SiC), the surface of the feeding part is metallized with aluminum, and the strap is made of aluminum.

The invention furthermore provides the float bath wherein the heater is in the form of a cylinder having an outer diameter of 23-50 mm.

The invention furthermore provides a method for float forming, comprising continuously pouring the glass in a molten state from one end side of the float bath onto the molten tin to form the glass into a glass ribbon on the molten tin and continuously drawing the glass ribbon from an end of the float bath.

The present inventors have achieved the invention under the following circumstances. Although alkali-free glass AN635 (trade name of Asahi Glass Co., Ltd.; forming temperature, 1,210° C.) had long been used as a glass for TFT-LCDs, AN100 (trade name of Asahi Glass Co., Ltd.; forming temperature, 1,268° C.) was developed as an alkali-free glass capable of satisfying a higher degree of requirements concerning glass properties as stated above. However, it was found that when a float bath which has been used for the float forming of AN635 is used for the float forming of AN100, the load to be imposed on the heaters per unit area thereof becomes too high, resulting in difficulties in long-term stable production. Even when the volume flow rate V_{g} is increased in such a range as not to considerably enhance the fear of increasing top specks in order to reduce the load to be imposed on the heaters, the upper-space atmosphere temperature Tᵣ can only be lowered down to 320° C. at the most. It was thus found that use of this float bath for the long-term production of AN100 is undesirable.

In order to overcome that problem, the present inventors directed attention to the heat-radiating properties of heaters and constituted heaters so as to cause the surfaces of the heater end parts to efficiently dissipate heat to thereby prevent the straps from overheating even when the upper-space atmosphere temperature Tᵣ has risen. Namely, investigations were made on conditions under which the heater end part temperature Tₛ in the state in which the upper-space atmosphere temperature Tᵣ had risen by 20° C. (e.g., the state in which the Tᵣ had risen from 300° C. to 320° C.) could be lowered to the heater end part temperature Tₛ in the state in which the upper-space atmosphere temperature Tᵣ had not risen (e.g., 300° C.).

First, in float baths heretofore in use, the heaters are ones obtained by forming silicon carbide (SiC) into a nearly cylindrical shape and the length of each heater end part located in the upper space is 46 mm. Each feeding part has been formed by metallizing the surface of the SiC with aluminum by, e.g., impregnation with aluminum over a length of 40 mm from the end of the heater end part. The feeding part has an aluminum strap in a flat net string form attached thereto, and the part of the heater end part excluding the feeding part (hereinafter referred to as non-feeding part) is a part which has a length of 6 mm and in which the SiC is exposed.

Furthermore, with respect to the surface emissivities of the feeding part (in the state of having the strap attached thereto; for convenience of calculation; the same applies hereinafter) and non-feeding part of each heater, the emissivity of the feeding part is 0.7 and that of the non-feeding part, in which SiC is exposed, is 1.0 when the emissivity of a carbon paste which shows properties closely akin to those of a black body is taken as 1.0. The surface emissivities of the feeding part and non-feeding part of each heater were calculated in the following manner.

First, the following test pieces are prepared: test piece a obtained by applying a carbon paste (carbon adhesive ST-201, manufactured by Nisshinbo Industries, Inc.) to the surface of a nearly cylindrical member made of SiC; test piece b obtained by metallizing the surface of the SiC member; test piece c obtained through the metallizing and attachment of a strap to the member; and test piece d comprising the SiC member in which the SiC is exposed on the surface. These test pieces are placed in an electric heating oven having an atmosphere temperature kept at 300° C., and are heated for a given time period (5 hours or longer) until the temperature of each test piece reaches 300° C.

Subsequently, the test pieces heated to 300° C. are taken out of the electric heating oven and, immediately thereafter (within 30 seconds), the surface temperature of each test piece is measured with an infrared thermal imaging apparatus (Thermo Tracer TH3104MR, manufactured by NEC San-ei Instruments, Inc.).

On the assumption that the emissivity of test piece a, which has been coated with a carbon paste, is 1.0, the emissivities of test piece b, which has undergone metallizing, test piece c, which has a strap attached thereto, and test piece d, in which the SiC is exposed, are calculated using the following equation (A).
1.0×(T_{c}+273)⁴=1/ε×(T+273)⁴ (A)

In the equation, T_{c} is the surface temperature (° C.) of the test piece coated with the carbon paste; T is the surface temperature of test piece b, which has undergone metallizing, test piece c, which has a strap attached thereto, or test piece d, in which the SiC is exposed; and ε is the emissivity of test piece b, which has undergone metallizing, test piece c, which has a strap attached thereto, or test piece d, in which the SiC is exposed. The emissivities ε of test pieces b, c, and d were found to be 0.7, 0.7, and 1.0, respectively, from equation (A).

The present inventors made various measurements and calculations with respect to this float bath and established the following calculation model based on the results thereof. FIG. 1 is a view illustrating this calculation model.

This calculation model is a heat balance model for the upper space 20. Heat input Qᵢₙ to the upper space 20 is regarded as wholly attributable to radiant heat from the heater end parts. Heat input Qᵢₙₖ from the feeding parts of the heaters is then expressed by equation (1).
Qᵢₙₖ=εₖh·Sₖ·N(Tₛ−Tᵣ) (1)

Furthermore, heat input Qᵢₙₙ from the non-feeding parts of the heaters is expressed by equation (2).
Qᵢₙₙ=εₙh·Sₙ·N(Tₛ−Tᵣ) (2)

In the equations, Sₖ is the surface area of the feeding parts of the heaters; Sₙ is the surface area of the non-feeding parts of the heaters; εₖ is the emissivity of the feeding parts of the heaters; εₙ is the emissivity of the non-feeding parts of the heaters; N is the number of heaters per unit area in a horizontal plane of the roof brick layer 16; h is the coefficient of heat transfer by radiation; and Tₛ is the temperature of the heater end parts.

Consequently, the heat input Qᵢₙ to the upper space 20 is expressed by equation (3).
Qᵢₙ=Qᵢₙₖ+Qᵢₙₙ (3)

On the other hand, heat output Qₒᵤₜ from the upper space 20 is the sum of heat output Qₒᵤₜₐ to the outside through that part of the roof casing 19 which is in contact with the upper space 20 (hereinafter, that part is referred to as wall part) and the quantity of heat Q_{outg} consumed by elevating the temperature of the atmosphere gas supplied to the upper space 20. Qₒᵤₜₐ is expressed by equation (4) using outside temperature Tₐ, the area of the wall part A_{w}, and the overall coefficient of heat transfer h_{c}.
Qₒᵤₜₐ=h_{c}A_{w}(Tᵣ−Tₐ) (4)

Furthermore, Q_{outg} is expressed by equation (5) using Tᵣ, Tₐ, and the volume flow rate V_{g}, density ρ_{g}, and specific heat C_{g} of the atmosphere gas.
Q_{outg}=V_{g}ρ_{g}C_{g}(Tᵣ−Tₐ) (5)

Consequently, the heat output Qₒᵤₜ from the upper space 20 is expressed by equation (6).
Qₒᵤₜ=Qₒᵤₜₐ+Q_{outg} (6)

In the state of thermal equilibrium in which Qᵢₙ=Qₒᵤₜ, equation (7) holds.
Qᵢₙₖ+Qᵢₙₙ=Qₒᵤₜₐ+Q_{outg} (7)

When the case where upper-space atmosphere temperature Tᵣ=320° C. is expressed with suffix 1, and the case where upper-space atmosphere temperature Tᵣ=300° C. is expressed with suffix 2, then equation (7) is converted to equation (8) and equation (9), respectively.

$$\begin{matrix}\begin{matrix}{∈}_{k} h \cdot {S}_{k} \cdot N ( {T}_{s 1} - {T}_{r 1} ) + {∈}_{n} h \cdot {S}_{n} \cdot N ( {T}_{s 1} - {T}_{r 1} ) = \\ {h}_{c} {A}_{w} ( {T}_{r 1} - {T}_{a} ) + {V}_{g} {ρ}_{g} {C}_{g} ( {T}_{r 1} - {T}_{a} ) \end{matrix} & ( 8 ) \\ \begin{matrix}{∈}_{k} h \cdot {S}_{k} \cdot N ( {T}_{s 2} - {T}_{r 2} ) + {∈}_{n} h \cdot {S}_{n} \cdot N ( {T}_{s 2} - {T}_{r 2} ) = \\ {h}_{c} {A}_{w} ( {T}_{r 2} - {T}_{a} ) + {V}_{g} {ρ}_{g} {C}_{g} ( {T}_{r 2} - {T}_{a} ) \end{matrix} & ( 9 )\end{matrix}$$

Equation (8) and equation (9) are rearranged to obtain equation (10).
(Tₛ₁−Tᵣ₁)/(Tₛ₂−Tᵣ₂)=(Tᵣ₁−Tₐ)/(Tᵣ₂−Tₐ) (10)

When the outside temperature Tₐ was 40° C., the heater end part temperature Tₛ was measured in an area where the upper-space atmosphere temperature Tᵣ was 200° C. As a result, the Tₛ was found to be 400° C. Since the heater end part temperature Tₛ₁ in an area where the upper-space atmosphere temperature is Tᵣ₁ (=320° C.) is difficult to actually measure because of the structure of the roof of the float bath and from an operation standpoint, it is assumed that the temperature Tₛ₁ was 520° C. (400+(320−200)). When Tₛ₁=520° C., Tᵣ₁=320° C., and Tₐ=40° C. are substituted into equation (10), then the heater end part temperature Tₛ₂ at the time when the upper-space atmosphere temperature is Tᵣ₂ (=300° C.) is assumed to be Tₛ₂=486° C. Incidentally, the heater end part has an outer diameter L₃ of 25 mm (the thickness of the strap is assumed to be 0 for the convenience of calculation), the feeding part has an L₁ of 40 mm as measured from the end of the heater end part, and the non-feeding part, in which the SiC is exposed, has an L₂ of 6 mm. Namely, the feeding part of the heater has a surface area Sₖ of 3,632 mm² and an emissivity εₖ of 0.7, and the non-feeding part of the heater has a surface area Sₙ of 471 mm² and an emissivity εₙ of 1.0. Incidentally, the surface areas Sₖ and Sₙ of the feeding part and non-feeding part of the heater mean the surface area of the outer surface (the periphery and end surface) of the heater.

Next, an investigation is made on a method by which the heater end part temperature Tₛ is lowered from Tₛ₁ to Tₛ₂ even when the upper-space atmosphere temperature is Tᵣ₁ (=320° C.) by appropriately setting the surface area of the feeding part of the heater and the surface area of the non-feeding part of the heater (S′ₖ and S′ₙ, respectively).

Tᵣ₂ in equation (9) is replaced with Tᵣ₁ to obtain equation (11).

$$\begin{matrix}{∈}_{k} h \cdot {S}_{k}^{{}^{′}} \cdot N ( {T}_{s 2} - {T}_{r 1} ) + {∈}_{n} h \cdot {S}_{n}^{′} \cdot N ( {T}_{s 2} - {T}_{r 1} ) = \\ {h}_{c} {A}_{w} ( {T}_{r 1} - {T}_{a} ) + {V}_{g} {ρ}_{g} {C}_{g} ( {T}_{r 1} - {T}_{a} )\end{matrix} \qquad ( 11 )$$

Equation (12) is obtained from equation (8) and equation (11).
{(εₖSₖ+εₙSₙ)(Tₛ₁−Tᵣ₁)}/{(εₖS′ₖ+εₙS′ₙ)(Tₛ₂−Tᵣ₁)}=1 (12)

Tᵣ₁=320° C., Tₛ₁=520° C., and Tₛ₂=486° C. are substituted into equation (12) to obtain equation (13).
εₖS′ₖ+εₙS′ₙ=1.2048(εₖSₖ+εₙSₙ) (13)

Sₖ=3,632 mm², εₖ=0.7, Sₙ=471 mm², and εₙ=1.0 are substituted into equation (13) to obtain the following equation.
εₖS′ₖ+εₙS′ₙ=3,630 mm²

Namely, by setting the surface areas so as to satisfy the following relationship,
εₖS′ₖ+εₙS′ₙ≧3,630 mm² (14)
the heater end part temperature Tₛ₁ at the time when the upper-space atmosphere temperature is Tᵣ₁=320° C. can be lowered to or below the heater end part temperature Tₛ₂ at the time when the upper-space atmosphere temperature is Tᵣ₂=300° C.

### ADVANTAGE OF THE INVENTION

According to the invention, a high-viscosity glass which, when subjected to float forming with a conventional float bath, considerably shortens the life of the equipment or considerably enhances the fear of generating or increasing top specks can be formed by float forming without enhancing such fears.

### BRIEF DESCRIPTION OF THE DRAWINGS

FIG. 1 is a calculation model illustrating a heat balance in an upper space.

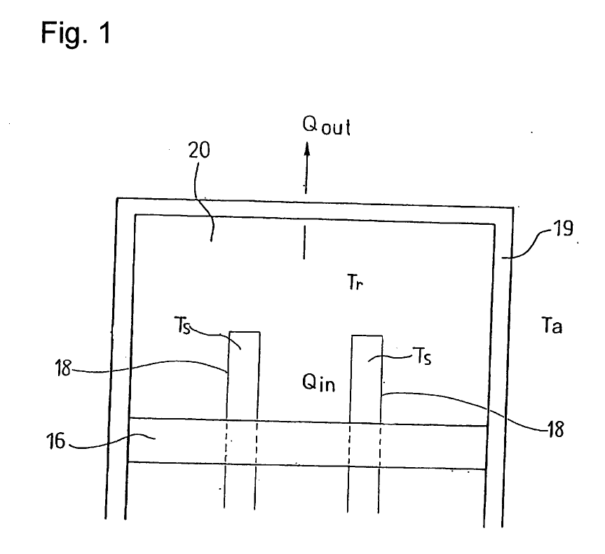

FIG. 2 is a sectional view diagrammatically illustrating a float bath as one embodiment of the invention.

FIG. 3 is an enlarged sectional view of main parts of the float bath in FIG. 2.

### DESCRIPTION OF REFERENCE NUMERALS

10 float bath
11 molten tin
12 bottom
14 roof
16 roof brick layer
17 hole
18 heater
18A feeding part
18B non-feeding part
20 upper space
21 lower space
24 strap

### BEST MODE FOR CARRYING OUT THE INVENTION

A preferred embodiment according to the invention will be explained below in detail based on the drawings.

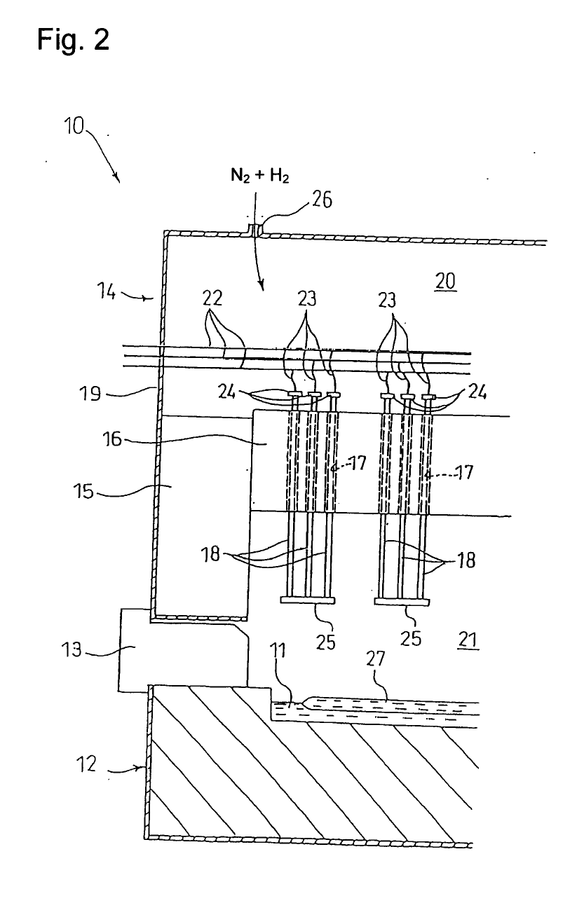

FIG. 2 is a view diagrammatically illustrating a section (part) of a float bath as one embodiment of the invention. The float bath 10 comprises a bottom 12 filled with molten tin 11 and a roof 14 covering the bottom 12. The maximum value of the width of the molten tin 11 typically is 1-10 m.

The roof 14 comprises: a roof casing 19 which is made of steel and is suspended from an upper structure (not shown), e.g., beams, of the building in which the float bath 10 has been installed; a side wall 15 which is made of heat-insulating bricks and serves as a lining of a lower part of the roof casing 19; and a side seal 13 comprising steel boxes placed along edge parts of the bottom 12. The space in the roof 14 has been divided into two, i.e., an upper space 20 and a lower space 21, by a roof brick layer 16.

The roof brick layer 16 comprises a lattice framework comprising many support tiles (not shown) made of sillimanite and rail tiles (not shown) disposed thereon so as to perpendicularly mate therewith and nearly rectangular mating bricks placed on the framework. The support tiles are suspended from, e.g., the ceiling part of the roof casing 19 with members (not shown) called hangers. Namely, the roof brick layer 16 is horizontally held with the hangers at a desired height over the molten tin 11. Incidentally, both sides of the roof brick layer 16 are in contact with upper side parts of the side wall 15, and the top of the roof brick layer 16 is located at almost the same height as the top of the side wall 15. The roof brick layer 16 has holes 17 formed therein for disposing heaters 18 which penetrate the holes. The thickness of the roof brick layer 16 has conventionally been about 292 mm.

In the upper space 20, three bus bars 22 have been disposed parallel and connected to the heaters 18 through electric wires 23 and aluminum straps 24 in a flat net string form. The heaters 18 are usually made of SiC and have been disposed as units each comprising three heaters whose lower ends have been connected to each other with a connecting member 25.

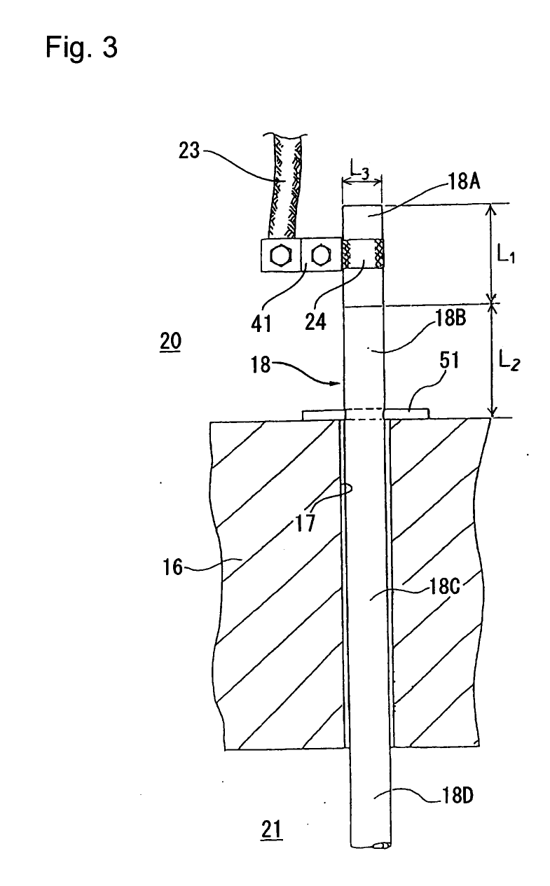

As shown in FIG. 3, an end part of each of these heaters 18 comprises: a feeding part 18A the surface of which has been metallized by impregnation with aluminum and which has a strap 24 attached thereto with caulking 41; and a non-feeding part 18B which is located beneath the feeding part 18A and in which the surface has not been metallized and the SiC is exposed. The feeding part 18A and the non-feeding part 18B are disposed so as to project above the roof brick layer 16 (i.e., into the upper space 20). Each heater 18 further has 18C, which is a part below 18B and is located in the hole 17 (18A, 18B, and 18C are non-heating parts), and a heating part 18D which is located below 18C and projects into the lower space 21. The heater 18 has a through-hole formed around the boundary between 18B and 18C, and the heater 18 is suspended from the roof brick layer 16 with an attachment pin 51 inserted into the through-hole. The outer diameter L₃ of the heater 18 is preferably from 23 mm to 50 mm, more preferably from 23 mm to 30 mm, especially preferably about 25 mm. The heaters 18 in this embodiment have been formed in a nearly cylindrical shape having an outer diameter L₃ of 25 mm.

In each heater 18 having an outer diameter of L₃ (25 mm in this embodiment), when the surface area and emissivity of the feeding part 18A are expressed by S′ₖ and εₖ, respectively, and the surface area and emissivity of the non-feeding part 18B are expressed by S′ₙ and εₙ, respectively, then the feeding part 18A and the non-feeding part 18B are formed in lengths of L₁ and L₂, respectively, regulated so as to satisfy S′ₖ·εₖ+S′ₙ·εₙ≧3,630 mm², which is derived from expression (14).

It is preferred in this embodiment that the surface of the feeding part 18A of each heater 18 be metallized by, e.g., aluminum impregnation from the standpoint of reducing the resistance of contact with the strap to be attached to the feeding part. The strap preferably is made of aluminum, and preferably is in the form of a flat net string. It should, however, be noted that the form is not limited to a flat net string. Consequently, the emissivity εₖ of the feeding part 18A to which a strap has been attached is 0.7 as stated above. However, in the case where the surface of the heater feeding part and the strap are made of another metal, the emissivity εₖ of the feeding part 18A is the emissivity of this metal.

In this embodiment, the non-feeding part 18B of each heater 18 has a surface in which the SiC is exposed and, hence, the emissivity εₙ of the non-feeding part 18B is 1.0 as stated above. However, there are cases where the emissivity is lower than 1.0. For example, a heater 18, although made of SiC, can have a non-feeding part emissivity lower than 1.0 because of, e.g., the production process, and a heater made of a material other than SiC can have such an emissivity value. In such cases, it is preferred to regulate the non-feeding part 18B so as to have an emissitivity εₙ equivalent to 1.0 by, e.g., applying a carbon paste to the surface of the non-feeding part 18B. It is also possible to regulate the emissivity of the feeding part having a strap attached thereto to 0.7 or higher by applying a carbon paste to the feeding part 18A and the strap as long as this does not adversely influence the feeding structure.

When each heater 18 is one in which the outer diameter L₃ is 25 mm (the thickness of the strap is assumed to be 0), the feeding part 18A and the strap 24 have an emissivity εₖ of 0.7, and the non-feeding part 18B has an emissivity εₙ of 1.0 and when the feeding part 18A, for example, has a length L₁ of 40 mm and a surface area S′ₖ of 3,632 mm² ((25/2)²×Π+25Π×40), then the upper-space atmosphere temperature may be controlled by increasing the surface area S′ₙ of the non-feeding part 18B so as to satisfy S′ₙ≧1,089 mm², which is derived from expression (14), as stated above. In this case, the non-feeding part 18B may have a length L₂ satisfying L₂≧13.9 mm (1,089/25Π).

The average circumferential-direction width of the gap between the inner surface of each hole 17 in the roof brick layer 16 and the 18C located in the hole 17 is generally 20 mm or smaller, more preferably 10 mm or smaller. The proportion of parts in which the average circumferential-direction width is 20 mm or smaller is preferably 80% or higher, more preferably 100%, based on the depth of the hole 17.

A further explanation is given by reference to FIG. 2 again. An atmosphere gas (mixed gas comprising N₂ and H₂) is supplied to the upper space 20 through a feed opening 26 in the roof casing 19 in the direction indicated by the arrow. This gas passes through the gap between each hole 17 and the 18C and flows into the lower space 21 to inhibit the molten tin 11 from oxidizing. This also inhibits the atmosphere temperature Tᵣ in the upper space 20 from rising. The flow rate of the atmosphere gas to be used in this case may be one which does not especially result in an increase in top specks.

In the method for float forming of the invention, a glass having a forming temperature (temperature at which the viscosity reaches 10⁴ poises) of 1,100° C. or higher can be float-formed with the float bath 10 having such constitution. Namely, the glass which has been melted in a glass melting furnace or the like is continuously poured onto the molten tin 11 through known spout lips (not shown) located at one end (upstream end) of the float bath 10 (e.g., located on the back side in FIG. 2). The molten glass continuously poured onto the molten tin 11 is formed into a glass ribbon 27 having a desired shape by a known method. The glass ribbon 27 is continuously drawn from the float bath 10 with lifting-out rollers (take-off rollers) which adjoin the other end (downstream end) of the float bath 10. Typically, the glass ribbon 27 is continuously drawn out at a rate of 1-200 tons/day.

The glass ribbon drawn out with the lifting-out rollers is annealed in a lehr (annealing kiln) and then cut into a desired size to give glass plates. By using the float bath 10 described above, a high-viscosity glass can be float-formed without especially increasing the number of top specks and without increasing the fear of arousing a trouble due to which the production should be stopped even in a short time period.

Incidentally, conventional heaters may be used in areas where the upper space does not heat up beyond 300° C. (e.g., lehr side in the float bath).

The invention should not be construed as being limited to the embodiment described above, and modifications, improvements, etc. can be suitably made therein. The details shown as examples in the embodiment described above, such as the bottom, roof, roof brick layer, upper space, lower space, heaters, atmosphere gas, temperatures, drawing rate, and material, shape, size, type, number, location, and thickness of each member of the float bath, can be changed at will as long as the object of the invention is not defeated.

Furthermore, the high-viscosity glass is not limited to glasses for TFT-LCD substrates, and may be, for example, a glass for plasma display panel substrates. The float bath of the invention may be used not only for high-viscosity glasses but in the float forming of, e.g., soda-lime glass.

While the invention has been described in detail and with reference to specific embodiments thereof, it will be apparent to one skilled in the art that various changes and modifications can be made therein without departing from the spirit and scope thereof.

### INDUSTRIAL APPLICABILITY

According to the invention, a high-viscosity glass which, when subjected to float forming with a conventional float bath, considerably shortens the life of the equipment or considerably enhances the fear of generating or increasing top specks can be formed by float forming without enhancing such fears.

1. A float bath which comprises a bottom filled with molten tin and a roof covering the bottom and in which the space in the roof is divided into an upper space and a lower space by a roof brick layer and a heater is disposed so as to penetrate a hole formed in the roof brick layer,
wherein a heater end part located in the upper space has a feeding part having a strap attached thereto for feeding power to the heater, and
wherein the heater end part is constituted so as to satisfy the following relationship:
S′ₖ·εₖ+S′ₙ·εₙ≧3,630 mm²
when the surface area and emissivity of the feeding part are expressed by S′ₖ and εₖ, respectively, and the surface area and emissivity of the heater end part excluding the feeding part are expressed by S′ₙ and εₙ, respectively.

2. The float bath of claim 1, wherein the emissivity of the feeding part, εₖ, is 0.7 or higher and the emissivity of the heater end part excluding the feeding part, εₙ, is 1.0.

3. The float bath of claim 1, wherein the heater is made of silicon carbide (SiC), the surface of the feeding part is metallized with aluminum, and the strap is made of aluminum.

4. The float bath of claim 1, wherein the heater is in the form of a cylinder having an outer diameter of 23-50 mm.

5. A method for float forming, comprising continuously pouring the glass in a molten state from one end side of the float bath of any one of claims 1 to 4 onto the molten tin to form the glass into a glass ribbon on the molten tin, and continuously drawing the glass ribbon from an end of the float bath.
